(19) United States
(12) Patent Application Publication
(10) Pub. No.: US 2026/0369925 A1
(43) Pub. Date: Nov. 19, 2026

(54) Cable Connector Strain Relief System

(71) Applicant: HARTING Electric Stiftung & Co. KG, Espelkamp (DE)

(72) Inventors: Julie RUTTER, Elgin, IL (US); Juan SAMANIEGO, Elgin, IL (US); Karol GOSZCZYNSKI, Big Rock, IL (US); Jacob GEORGE, Elgin, IL (US); Matthias WIEHE, Lübbecke (DE)

(73) Assignee: HARTING Electric Stiftung & Co. KG, Espelkamp (DE)

(21) Appl. No.: 19/136,555

(22) PCT Filed: Dec. 20, 2023
(86) PCT No.: PCT/IB2023/062976

§ 371 Date: Jun. 6, 2025

Related U.S. Application Data
(60) Provisional application No. 63/435,109, filed on Dec. 23, 2022.

(51) Int. Cl. H01R 13/58

(52) U.S. Cl. CPC H01R 13/5825

(57) ABSTRACT

A cable connector includes a housing. The housing has a cable opening for receiving a cable with a plurality of wires therethrough. A terminal insert is connected to the housing at a plug-in side thereof. A plurality of terminals are arranged within the terminal insert, each of the terminals being connected to a respective conductor within one of the plurality of wires. A strain relief element is arranged within the housing and designed to transfer a force into the housing. The strain relief element includes a plurality of pass-through openings for the wires. A plurality of wire sleeves is arranged within the housing, one of the wire sleeves each being firmly connected to one of the wires in an exposed wire section of the cable between the strain relief element and the terminal insert.

### CROSS-REFERENCE TO RELATED APPLICATION

This application claims the benefit of U.S. Provisional Patent Application No. 63/435,109, filed 23 Dec. 2022, the contents of which is incorporated by reference in its entirety.

### TECHNICAL FIELD

The present disclosure relates to a strain relief system for a cable connector.

### BACKGROUND

Cable connectors have to meet increasingly demanding industry requirements. For example, certain connectors have to comply with the UL 1682 standard. This standard applies to pin and sleeve type plugs, receptacles, power inlets, and connectors, rated up to 800 A and up to 600 V, and which may include up to eight pilot contacts. These devices are intended to provide power from branch circuits, or are for direct connection to the branch circuit, using copper conductors, for use in either indoor or outdoor nonhazardous locations.

Connectors may also have to comply with the UL 2875 standard. This standard covers modular multi-pole connectors for use with specific identified cable types and when assembled create a modular cable system that consists of electrical cables, field installed or factory assembled modular multi-pole connectors and other associated system devices. These modular cable systems are intended for installation within commercial and industrial locations such as material handling distribution systems and wind turbine towers, for example.

The UL 1682 and UL 2875 standards require connectors to meet a cable secureness, aka “pull test,” requirement. The cable secureness test requires, for example, connectors rated for electric loads between 36 and 200A to withstand a pull force of 667 N for 60 seconds of the cable in the connector, limiting a permissible axial displacement of the supply conductors, conductor insulation, or outer jacket of the cable to 2.4 mm. This requirement has been satisfied with large connectors, but the industry is demanding smaller connectors to meet the same requirement.

### SUMMARY

Strain relief mechanisms for cable connectors generally absorb a pulling force acting on the cable into a connector housing. This prevents undesirable movement of wires and terminals. Those wires and terminals carry electric loads of, for example, up to 200 A. One approach provides strain relief by clamping the cable and compressing the cable's outer jacket with a clamp gland. A pulling force acting on the cable is then transferred by friction from the clamp gland onto a connector housing. However, the clamping of a cable's outer jacket has several disadvantages. For example, the compression of wires within the cable can cause changes in wire resistance and result in hot spots. Clamping glands may severely deform the cable and cause the outer jacket to be damaged.

The present disclosure provides an improved strain relief, which does not rely on clamping the cable's outer jacket. Rather, one or more wires within the cable are secured against strain. The wires can be secured individually, or in groups of two or more wires.

In one example, a cable connector includes a housing. The housing has a cable opening for receiving a cable with a plurality of wires therethrough. A plurality of terminals are arranged within a terminal insert, each of the terminals being connected to a respective conductor within one of the plurality of wires. A strain relief element includes a plurality of pass-through openings. A plurality of wire sleeves are connected to the wires, one of the wire sleeves each being firmly connected to one of the wires in an exposed wire section of the cable between the strain relief element and the terminal insert. The strain relief element may be plate-shaped.

Each of the pass-through openings has a width and a length. The wire sleeves have an outer diameter which exceeds the width of a corresponding pass-through opening. However, the outer diameter of the wire sleeve may be shorter than the length of the corresponding pass-through opening. The pass-through openings may include a semi-circular portion having a diameter that corresponds to a diameter of the wire.

An outer portion of the strain relief element is supported within the housing, for example on a flange provided within the housing. When in use, the wire sleeves pass a pull-force acting through the cable on the wires into the strain relief element. In turn, the strain relief element passes the pull-force into the housing.

The strain relief element may include two pass-through openings that are connected by a connecting slot. An access slot may extend from a side of the strain relief element to the connecting slot. In one particular example, the strain relief element may include two pairs of connected pass-through openings that are accessible from a side of the strain relief element by a joint access slot, and one single pass-through opening that is accessible from a side of the strain relief element by a separate access slot. The strain relief element may also include a spacer that extends forwardly from a center of the strain relief element.

In another example, the strain relief element may include one circular pass-through opening arranged centrally between four stadium-shaped pass-through openings.

The wire sleeves preferably consist essentially of polyolefin, a heat-shrink material. A hot-melt adhesive layer may be arranged between the wire sleeves and the wires.

In another example, the strain relief element may comprise a single pass-through opening. A single wire may extend through the single pass-through opening and be secured against being pulled back by a single wire sleeve.

It is also possible that multiple wires extend through one pass-through opening and are collectively held together and secured against being pulled back by one wire sleeve.

A method for mounting the disclosed cable connector to a cable includes several steps, including:
inserting the cable through a cable opening of a housing;
arranging wires of the cable to extend through pass-through openings of a strain relief element;
sliding a plurality of wire sleeves onto the wires, one of the wire sleeves each being placed onto one or more of the wires in an exposed wire section of the cable;
applying heat to the wire sleeves, thereby causing the wire sleeves to shrink and become firmly connected to the wires;
inserting terminals of each wire into a terminal insert; and
connecting the terminal insert to the housing.

Those steps may be performed in any technically feasible order. For example, applying the heat to the wire sleeves may be performed after arranging the wires of the cable to extend through the pass-through openings of the strain relief element. This allows threading the wires and attached terminals through the pass-through openings of the strain relief element. Alternatively, arranging the wires of the cable to extend through the pass-through openings of the strain relief element may include sliding one of the wires laterally through an access slot into one of the pass-through openings. Then, the wire sleeves may be secured to the wires even before the wires are inserted into the strain relief element.

Applying heat to the wire sleeves may include melting an adhesive lining on an inside of the wire sleeves and forming an adhesive bond between the wire sleeves and the wires.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 is a perspective front and side view of a cable connector.

FIG. 2 is the perspective front and side view of the connector as in FIG. 1, with a connector housing removed to show the inside of the cable connector.

FIG. 3 is a detailed perspective rear view of a strain relief element as used in the connector shown in FIG. 1.

FIG. 4 is a schematic view of a cable end.

FIG. 5 is a perspective cross sectional top view of the connector as in FIG. 1.

FIG. 6 is a perspective side view of a second cable connector.

FIG. 7 is a perspective rear and side cross section through the second connector as in FIG. 6.

FIG. 8 is a detailed view of the strain relief element and a wire sleeve as used in the second connector shown in FIG. 6.

### DETAILED DESCRIPTION

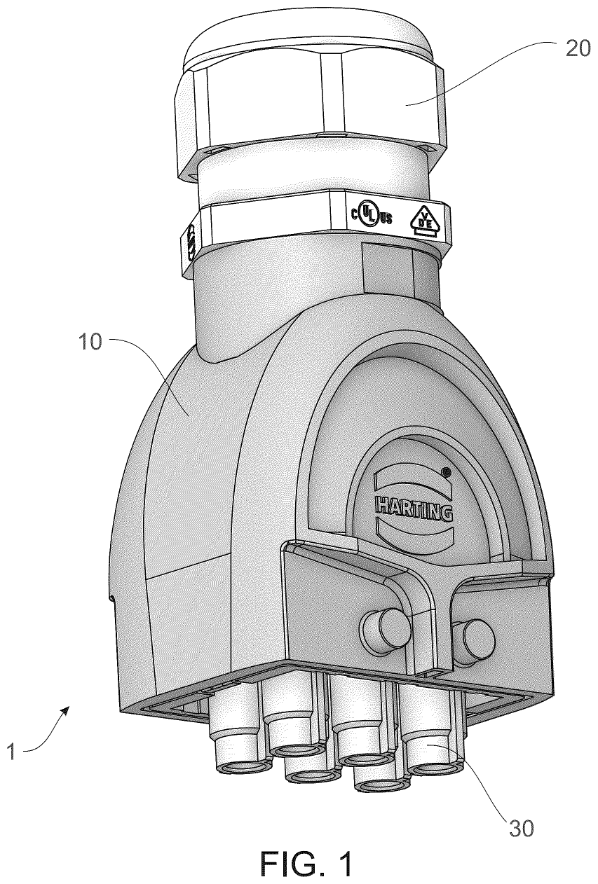

FIG. 1 shows a cable connector 1. The connector 1 includes a housing 10. A terminal insert 30 extends outwardly from a plug-in side at the front of the housing 10. A cable gland 20 is screwed into a rearward cable opening of the housing 10 on a cable-exit side of the connector 1.

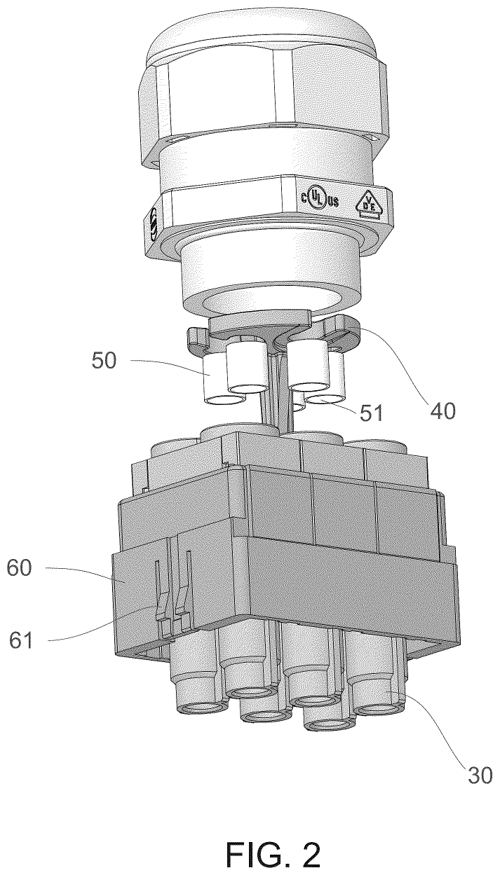

FIG. 2 shows the cable connector 1 as in FIG. 1 without the housing 10. Inside the housing 10, the terminal insert 30 is held within a frame 60. The frame 60 is secured to the housing 10 by snap-locks 61.

Arranged within the housing 10 is also a strain relief element in form of a strain relief plate 40. In front of the strain relief plate 40, that is on its plug-in side, are a plurality of wire sleeves 50. When assembled, the wire sleeves 50 are firmly connected to individual wires 74 of a cable 70.

FIG. 4 illustrates schematically the anatomy of a cable 70. Arranged within the cable 70 are several wires 74 to carry electric current. Each of the wires comprises a conductor 73 within a wire insulation 72. The wires 74 are arranged within an outer jacket 71. For installation within the cable connector, the outer jacket 71 is stripped from the cable 70 to create an exposed wire section 75. The exposed wire section is arranged within the housing 10, on the plug-in side of the cable gland 20. Within an exposed conductor section 76 of the wires 74, the respective conductors 73 are connected to terminals 31. The cable connector terminals are typically male but can also be female. The terminals may be of a screw terminal type, a crimp terminal type, or a cage-clamp terminal type.

FIG. 4 shows a single wire sleeve 50 attached to one of three wires 74. In practice, more than one and preferably all wires 74 are fitted with a respective wire sleeve 50. Alternatively, one wire sleeve 50 can be used with two or more wires 74. The wire sleeve 50 is firmly attached to the insulation 72 of the wire 74. The wire sleeve 50 may be a cylindrical heat-shrink tube that has been shrunk onto the wire 74.

For optimal adhesion, the sleeve 50 may be a cylindrical heat shrink tube having an adhesive lining on its inside. During installation, when the cylindrical heat-shrink tube is heated and shrinks, the adhesive lining melts and forms an adhesive layer 51 between the wire insulation 72 and the sleeve 50.

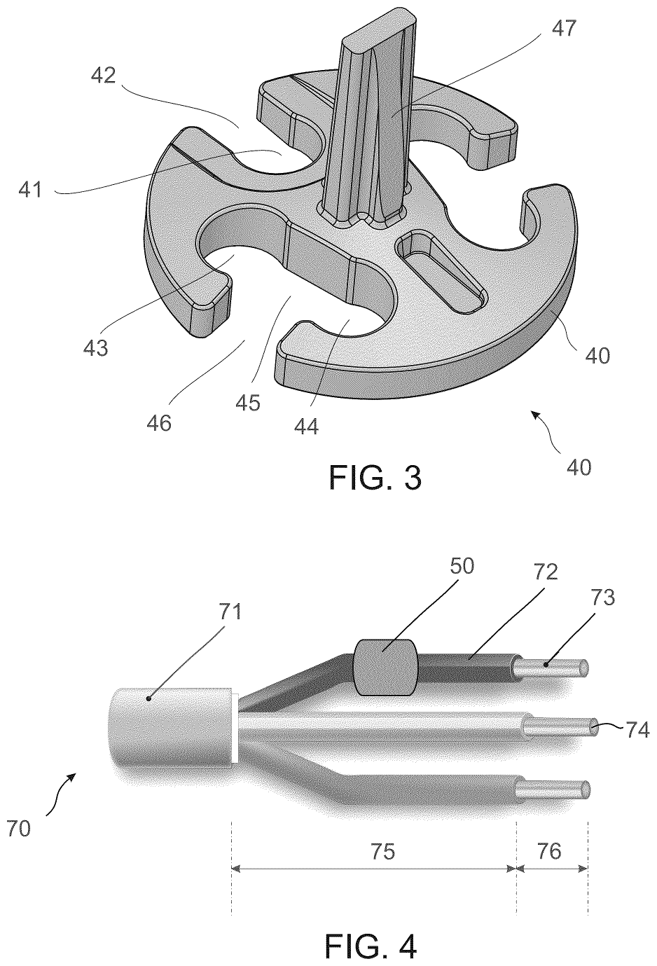

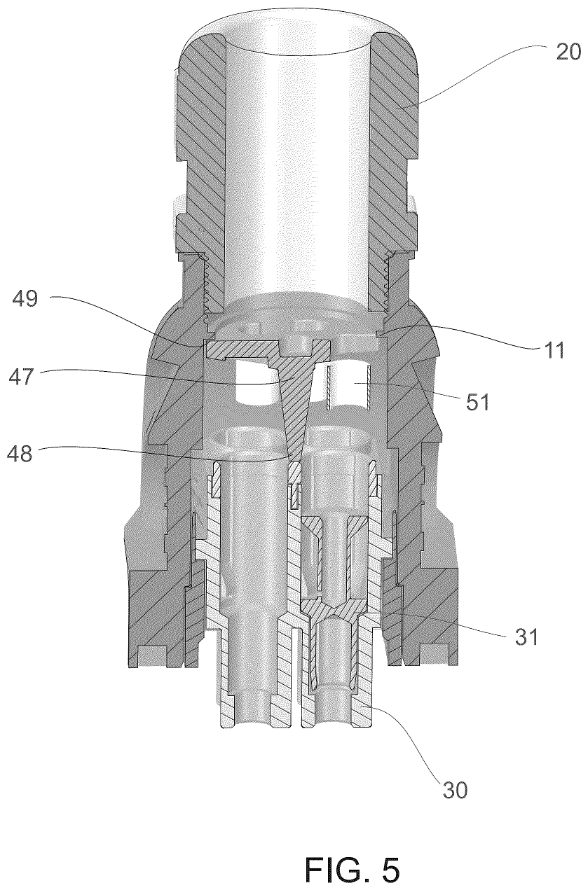

Referring now to FIG. 3, the sleeves 50 cooperate with the strain relief plate 40 to prevent the wires 74 from being pulled rearwardly out of the cable connector 1. For that purpose, the strain relief plate 40 comprises wire pass-through openings 41. The pass-through openings 41 are just wide enough to accommodate a single wire 74 including its insulation 72 within the exposed wire section 75 of the cable 70. The sleeves 50 rest on the strain relief plate 40 in areas adjacent to the pass-through openings 41. A pulling force applied to the cable 70, and through it onto a wire 74, is passed through the wire's insulation 72 and the sleeve 50 into the strain relief plate 40. The strain relief plate 40 is in turn supported on a circumferential outside portion by the connector housing 10.

As shown in FIG. 4, a single pass-through opening 41 may have a semi-circular shape which extends into a rectangular slot 42. The rectangular slot 42 may form a radial access slot 42 that is open at a side of the strain relief plate 40. The access slot 42 allows installation of the strain relief plate 40 after sleeves 50 have already been mounted on the wires. That is, a wire can be pushed sideways along a length of the access slot 42 into the pass-through opening 41.

As also illustrated in FIG. 4, two adjacent pass-through openings 43, 44 may be connected by a generally rectangular connecting slot 45. The slot 45 may open outwardly into a joint access slot 46. In this configuration, two wires 74 can be inserted, one at a time, sideways through the joint access slot 46 into the connecting slot 45, and from there into their final installed position within the adjacent pass-through openings 43, 44.

The strain relief plate 40 shown in FIG. 3 has a circular basic shape and is designed to accommodate a total of five wires. The strain relief plate 40 for that purpose includes two pairs of connected pass-through openings 43, 44 and one single pass-through opening 41.

A spacer 47 extends forwardly from a center of the strain relief plate 40. As shown in the cross-section view of FIG. 4, a tip 48 of the spacer 47 pushes onto the terminal insert 30. At the same time, a circumferential outer portion 49 of the strain relief plate 40 abuts an inwardly extending circular flange 11 of the housing 10. The strain relief plate 40 is so firmly held within the cable connector 1 and secured against tilting when subjected to asymmetrical forces.

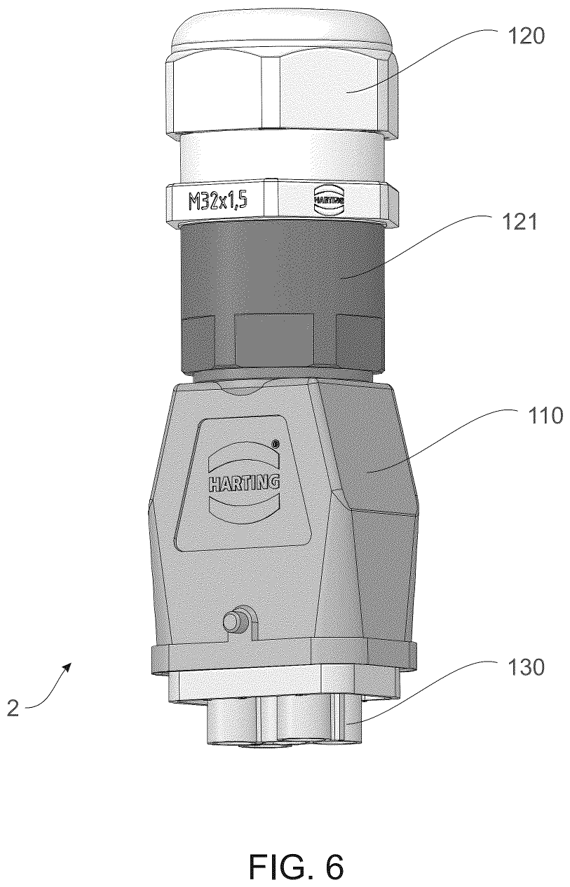

FIGS. 6-8 show an alternative embodiment of a cable connector 2 with strain relief for individual wires of a cable. The connector 2 includes a housing 110, and a terminal insert 130. A cable gland 120 is connected to a rearward cable opening of the housing 110 by a cable gland adapter 121.

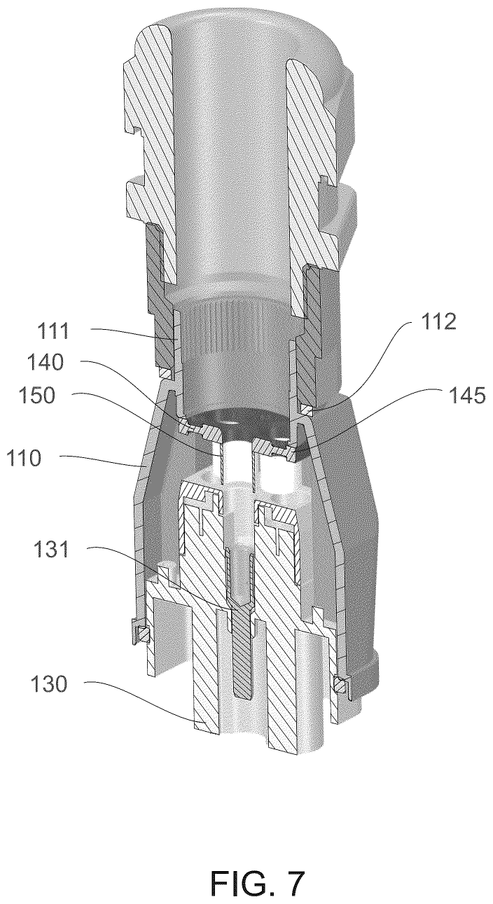

The cross-sectional view of FIG. 7 shows a strain relief plate 140 arranged within the housing 110. An outer portion 145 of the strain relief plate 140 abuts an inner end of a cable inlet guide 111 of the housing 110. The cable gland adapter 121 is secured around an opposite outer end of the cable inlet guide 111. A seal 112 may be arranged between the cable gland adapter 121 and the housing to prevent ingress of contaminants into the connector 2.

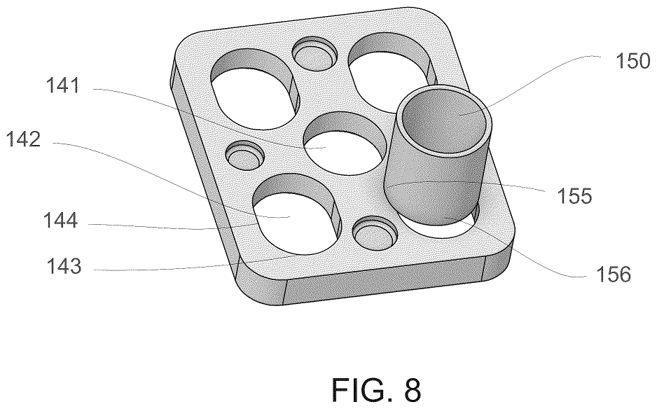

FIG. 8 is a perspective front view of the strain relief plate 140. For illustration purposes, only one of five wire sleeves 150 is illustrated. The strain relief plate 140 has a generally rectangular shape with rounded corners. A circular pass-through opening 141 is arranged within the center of the strain relief plate 140. The central pass-through opening 141 is a circular hole, i.e., it includes two connected semi-circular sides. Four elongated pass through openings 142 are arranged in a 2×2 matrix within the strain relief plate 140 around the central through-opening 141. Each elongated pass through opening 142 has a stadium-shaped cross section, including two semi-circular portions 143 adjoined by a rectangular slotted portion 144.

As shown in FIG. 8, a face of the cylindrical wire sleeve 150 abuts the strain relief plate 140 in an area around the pass through openings 141, 142. A width of the central pass-through opening 141 corresponds to a diameter of the wire that extends through it when assembled. The diameter of the wire is the same as an inner diameter of the wire sleeve 150 that has been shrunk onto the wire's insulation. Similarly, a diameter of the semi-circular portions 143 of the elongated pass through openings 142 and a width of the rectangular slotted portion 144 correspond to an outer diameter of the wire, and consequently an inner diameter of the corresponding cylindrical wire sleeve 150. The difference in shape between a cylindrical wire sleeve 150 and an elongated through opening 142 causes the wire sleeve 150 to abut the strain relief plate 140 only in an overlap portion 155 of the wire sleeve 150. A non-overlap portion 156 of the cylindrical wire sleeve 150 extends over the slotted portion 144. That is, the elongated through opening 142 is, in a length direction, larger than necessary to accommodate the wire that extends through it. This allows the strain relief plate 140 to be assembled after terminals have already been crimped onto the wire. The pass through openings 141, 142 are sufficiently large to allow a terminal to pass through the respective opening 141, 142. At the same time, the pass through openings 141, 142 are small enough, in a width direction, to prevent the cylindrical wire sleeves 150 from moving rearwardly within the connector 2.

The cylindrical wire sleeves 50, 150 may be formed of heavy duty shrink tubing. Such tubing may have a 3:1 shrink ratio, which allows the wire sleeves 50, 150 to slide over a terminal that has already been crimped onto the wire. The wire sleeves 50, 150 can then be secured to the wire by heating and causing the cylindrical wire sleeves 50, 150 to shrink. The cylindrical wire sleeves 50, 150 may be made essentially of irradiated modified polyolefin. The cylindrical wire sleeves 50, 150 may include a hot-melt adhesive liner on an inner side of the sleeve. Upon heating, the sleeve shrinks and the adhesive melts to form a secure bond to the wire insulation.

Assembly of a connector 2 with the disclosed strain relief comprises several steps. Those steps may be performed in any technically feasible order. In an early step, the cable gland 120, the cable gland adapter 121, and the housing 110 are placed onto the cable. An end of a cable 70 is stripped by removing its outer jacket 71 to expose the wires 74 therein in an exposed wire section 75. At an end of each wire 74, the insulation 72 is removed to expose the conductor 73 in an exposed conductor section 76. A terminal is crimped, screwed, or clamped onto the conductor 73. The retaining plate 140 is placed onto the cable, sliding one wire through each of the through openings 141, 142. Thereafter, one wire sleeve 150 is placed onto each wire. The wire sleeves 150 are aligned to rest on the strain relief plate 140. The wire sleeves 150 are then secured in place by applying heat, for example by use of a heat gun. The heat causes the wire sleeves 150 to shrink and firmly attach to the insulations 72 of the wires 74. The heat may also cause an adhesive layer within the wire sleeves 150 to melt and form an adhesive bond between a respective polyolefin sleeve 150 and the wire insulation 72. The terminals 131 are inserted into the terminal insert 130, and the terminal insert 130 is in turn secured to the housing 110.

Assembly of a connector 1 follows generally the same steps, in any technically feasible order. In case of the strain relief plate 40 used in connector 1, wires need not be threaded through any pass-through openings 41, 43, 44. Rather, the individual wires can be inserted sideways through the respective access slots 42, 46 and pushed into place. This allows the strain relief plate 40 to be installed even after the wire sleeves 50 have already been secured to the wires 74. In contrast, the access plate 140 must be placed onto the wires 74 before the wire sleeves 150 are secured to the wires 74. Either connector 1,2 allows for terminals 31, 131 to be installed before the respective strain relief plate 40, 140 is placed onto the wires 74.

While the connectors 1, 2 are shown with rearward facing cable exits, the disclosed strain relief system can, mutatis mutandis, be applied to connectors having cable side-exits.

While the connectors 1, 2 are shown with universal cable glands that provide a sealing fit of the cable to the housing, other cable entry protection concepts may be used. For example, clamping cable glands may be used to provide a secondary form a strain relief.

The connectors 1, 2 are shown with strain relief plates 40, 140. This illustrates only one possible shape of a strain relief element, and various other shapes may be used. For example, a semi-spherical strain relief element can be used. In that case, a flat front face of the semi-spherical strain relief element may support one or more wire sleeves. A spherical back of the semi-spherical strain relief element may be supported in a corresponding spherical socket of the housing.

The connectors 1, 2 are shown with strain relief elements being separate parts from the housing. That, also, is only one possible configuration. In an alternative configuration the strain relief element may be an integrally formed part of the housing. For example, the housing and the strain relief element may be injection molded as one piece.

FIG. 2 shows the terminal insert 30 being held within a frame 60 and the frame 60 being secured to the housing 10. Of course, the terminal insert can also be directly secured to the housing without the use of an intermediate frame. The terminal insert is generally an insulating body suitable for holding terminals.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements that are included within the spirit and scope of the following claims.

1. A cable connector (1, 2), comprising:
a housing (10, 110), the housing (10, 110) having a cable opening for receiving a cable (70) with a plurality of wires (74) therethrough;
a terminal insert (30, 130);
a plurality of terminals (31, 131) arranged within the terminal insert (30, 130), each of the terminals (31, 131) being connected to a respective conductor (73) within one of the plurality of wires (74);
a strain relief element (40, 140), the strain relief element (40, 140) comprising a pass-through opening (41, 43, 44, 141, 142); and
a wire sleeve (50, 150), the wire sleeve (50, 150) being firmly connected to one or more of the wires (74) in an exposed wire section (75) of the cable (70) between the strain relief element (40, 140) and the terminals (31, 131).

2. The cable connector (1, 2) as in claim 1,
wherein the pass-through opening (41, 43, 44, 141, 142) has a width and a length, and
wherein the wire sleeve (50, 150) has an outer diameter which exceeds the width of the pass-through opening (41, 43, 44, 141, 142).

3. The cable connector (1, 2) as in claim 1,
wherein the pass-through opening (41, 43, 44, 142) has a width and a length, the length being greater than the width, and
wherein the wire sleeve (50, 150) has an outer diameter which exceeds the width and is shorter than the length of the pass-through opening (41, 43, 44, 142).

4. The cable connector (1, 2) as in claim 1,
wherein an outer portion (49, 145) of the strain relief element (40, 140) is supported within the housing (10, 110),
wherein the wire sleeve (50, 150) passes a pull-force acting through the cable (70) on the one or more of the wires (74) into the strain relief element (40, 140), and
wherein the strain relief element (40, 140) passes the pull-force into the housing (10, 110).

5. The cable connector (1, 2) as in claim 1,
wherein the pass-through opening (41, 43, 44, 141, 142) includes a semi-circular portion having a diameter that corresponds to a diameter of a corresponding one of the wires (74).

6. The cable connector (1, 2) as in claim 1,
wherein the strain relief element (40) comprises a plurality of pass-through openings (41, 43, 44),
wherein two of the plurality of pass-through openings are connected by a connecting slot (45), and
wherein an access slot (46) extends from a side of the strain relief element (40, 140) to the connecting slot (45).

7. The cable connector (1, 2) as in claim 1,
wherein the strain relief element (40) comprises a plurality of pass-through openings (41, 43, 44),
wherein the plurality of pass-through openings (41, 43, 44) comprises
two pairs of connected pass-through openings (43, 44) that are accessible from a side of the strain relief element (40) by a joint access slot (46), and
one single pass-through opening (41) that is accessible from a side of the strain relief element (40) by an access slot

8. The cable connector (1, 2) as in claim 1,
wherein the strain relief element (140) comprises a plurality of pass-through openings (141, 142),
wherein the plurality of pass-through openings (141, 142) comprises one circular pass-through opening (141) arranged centrally between four stadium-shaped pass-through openings (142).

9. The cable connector (1, 2) as in claim 1. further comprising
a spacer (47) that extends forwardly from the strain relief element (40).

10. The cable connector (1, 2) as in claim 1,
wherein the wire sleeve (50, 150) consists essentially of polyolefin.

11. The cable connector (1, 2) as in claim 1,
further comprising a hot-melt adhesive layer (51) between the wire sleeve (50, 150) and the one or more of the wires (74).

12. A method for mounting a cable connector (1, 2) to a cable (70), comprising:
inserting the cable (70) through a cable opening of a housing (10, 110);
arranging wires (74) of the cable (70) to extend through pass-through openings (41, 43, 44, 141, 142) of a strain relief element (40, 140);
sliding a plurality of wire sleeves (50, 150) onto the wires (74), one of the wire sleeves (50, 150) each being placed onto one of the wires (74) in an exposed wire section (75) of the cable (70);
applying heat to the wire sleeves (50, 150), thereby causing the wire sleeves (50, 150) to shrink and become firmly connected to the wires (74);
inserting terminals (31, 131) of each wire (74) into a terminal insert (30, 130); and
connecting the terminal insert (30, 130) to the housing (10, 110).

13. The method as in claim 12,
wherein applying the heat to the wire sleeves (150) is performed after arranging the wires (74) of the cable (70) to extend through the pass-through openings (141, 142) of the strain relief element (140), and
wherein arranging the wires (74) of the cable (70) to extend through the pass-through openings (141, 142) of the strain relief element (140) includes threading the wires

(74) and attached terminals (31, 131) through the pass-through openings (141, 142) of the strain relief element (40, 140).

14. The method as in claim 12,
wherein arranging the wires (74) of the cable (70) to extend through the pass-through openings (41, 43, 44) of the strain relief element (40) includes sliding one of the wires (74) laterally through an access slot (42, 46) into one of the pass-through openings (41, 43, 44).

15. The method as in claim 12,
wherein applying the heat to the wire sleeves (50, 150) comprises melting an adhesive lining on an inside of the wire sleeves (50, 150), and forming an adhesive bond between the wire sleeves (50, 150) and the wires (74).
